(19) United States
(12) Patent Application Publication
(10) Pub. No.: US 2005/0070281 A1
(43) Pub. Date: Mar. 31, 2005

(54) System and method for providing mobile station registration in a traffic channel in a wireless communication system

(75) Inventors: Purva R. Rajkotia, Plano, TX (US); John Jubin, Richardson, TX (US)

Correspondence Address: DOCKET CLERK, P.O. DRAWER 800889, DALLAS, TX, 75380, US

(73) Assignee: SAMSUNG ELECTRONICS CO., LTD., Suwon-City (KR)

(21) Appl. No.: 10/672,607

(22) Filed: Sep. 26, 2003

(51) Int. Cl. H04Q 7/22

(52) U.S. Cl. 455/435.1; 455/560

(57) ABSTRACT

A system and method is provided for registering a wireless mobile station in a wireless communication system. The wireless mobile station sends and receives registration messages in a traffic channel. A traffic channel registration controller in a base station sends and receives registration messages in a traffic channel. The traffic channel registration controller communicates with a mobile switching center and causes the mobile switching center to register the mobile station. A registration accepted order is sent to the mobile station in a traffic channel to confirm a successful registration of the mobile station.

### TECHNICAL FIELD OF THE INVENTION

The present invention is directed to wireless communication systems and, more specifically, to a system and method for providing registration of a mobile station in a traffic channel in a wireless communication system.

### BACKGROUND OF THE INVENTION

Wireless communication systems, including cellular phones, paging devices, personal communication services (PCS) systems, and wireless data networks, have become ubiquitous in society. Wireless service providers continually try to create new markets for wireless devices and to expand existing markets by making wireless devices and services cheaper and more reliable. The price of end-user wireless devices, such as cell phones, pagers, PCS systems, and wireless modems, has been driven down to the point where these devices are affordable to nearly everyone and the price of a wireless device is only a small part of the end-user's total cost. To continue to attract new customers, wireless service providers concentrate on reducing infrastructure costs and operating costs, and on increasing handset battery lifetime, while improving quality of service in order to make wireless services cheaper and better.

To maximize usage of the available bandwidth, a number of multiple access technologies have been implemented to allow more than one subscriber to communicate simultaneously with each base station (BS) in a wireless system. These multiple access technologies include time division multiple access (TDMA), frequency division multiple access (FDMA), and code division multiple access (CDMA). These technologies assign each system subscriber to a specific traffic channel that transmits and receives subscriber voice/data signals via a selected time slot, a selected frequency, a selected unique code, or a combination thereof.

CDMA technology is used in wireless computer networks, paging (or wireless messaging) systems, and cellular telephony. In a CDMA system, mobile stations and other access terminals (e.g., pagers, cell phones, laptop PCs with wireless modems) and base stations transmit and receive data on the same frequency in assigned channels that correspond to specific unique orthogonal codes. For example, a mobile station may receive forward channel data signals from a base station that are convolutionally coded, formatted, interleaved, spread with a Walsh code and a long pseudo-noise (PN) sequence. In another example, a base station may receive reverse channel data signals from the mobile station that are convolutionally encoded, block interleaved, modulated by a 64-ary orthogonal modulation, and spread prior to transmission by the mobile station. The data symbols following interleaving may be separated into an in-phase (I) data stream and a quadrature (Q) data stream for QPSK modulation of an RF carrier. One such implementation is found in the TIA/EIA-95 CDMA standard (also known as IS-95). Another implementation is the TIA/EIA-2000 standard (also known as IS-2000).

The current generation of cellular phones is used primarily for voice conversations between a subscriber device (or wireless device) and another party through the wireless network. A smaller number of wireless devices are data devices, such as personal digital assistants (PDAs) equipped with cellular/wireless modems. Because the bandwidth for a current generation wireless device is typically limited to a few tens of kilobits per second (kbps), the applications for the current generation of wireless devices are relatively limited. However, this is expected to change in the next (or third) generation of cellular/wireless technology, sometimes referred to as “3G” cellular/wireless, where much greater bandwidth will be available to each wireless device (i.e., one hundred twenty five thousand bits per second (125 kbps) or greater). The higher data rates will make Internet applications for wireless devices much more common. For instance, a 3G cellular telephone (or a PC with a 3G cellular modem) may be used to browse web sites on the Internet, to transmit and receive graphics, to execute streaming audio or video applications, and the like. A much higher percentage of the wireless traffic handled by 3G cellular systems will be Internet protocol (IP) traffic and a lesser percentage will be traditional voice traffic.

Real-time streaming of multimedia content over Internet protocol (IP) networks has become an increasingly common application in recent years. As noted above, 3G wireless networks will provide streaming data (both video and audio) to wireless devices for real time applications. A wide range of interactive and non-interactive multimedia Internet applications, such as news on-demand, live TV viewing, video conferencing, live radio broadcasting (such as Broadcast.com), and the like, will provide “real time” data streaming to wireless devices. Unlike a “downloaded” video file, which may be retrieved first in “non-real” time and viewed or played back later, real time (or streaming) data applications require a data source to encode and to transmit a streaming data signal over a network to a receiver, which must decode and play the signal (video or audio) in real time.

When a mobile station (MS) is first used on a wireless network, the user must register the mobile station with the wireless network. The mobile station may be registered with the wireless network by transmitting a Registration Request message to a base station (BS). The base station that receives the Registration Request message forwards the Registration Request message to a mobile switching center (MSC). The mobile switching center registers the mobile station and sends a Registration Acceptance Message to the mobile station via the base station. The Registration Request message and the Registration Acceptance message are not sent through a traffic channel but are sent through an overhead channel.

In the current CDMA standard registration of a mobile station through a traffic channel is not allowed. The current CDMA standard contemplates that every mobile station will first be registered with the wireless network before the mobile station is allowed access to a traffic channel.

New types of mobile switching centers (MSC) have now entered the wireless network marketplace. These new types of mobile switching centers allow a mobile station to gain access to traffic channels without being previously registered. If a mobile station joins a wireless network that is controlled by such a mobile switching center, the mobile station will be able to send and receive messages on traffic channels without being registered in the wireless network. This situation can present a potential security risk. In addition, the wireless network will be unable to determine the location of the mobile station in the wireless network after a mobile call has terminated.

Therefore, there is a need for improved wireless network equipment and services for providing mobile station registration over a traffic channel in a wireless network. In particular, there is a need for a system and method for providing mobile station registration over a traffic channel in a wireless network so that a mobile station can be properly located within the wireless network.

### SUMMARY OF THE INVENTION

To address the above-discussed deficiencies of the prior art, it is a primary object of the present invention to provide a system and method for providing mobile station registration over a traffic channel in a wireless network.

In the system and method of the present invention a wireless mobile station sends registration messages to a base station in a traffic channel. A traffic channel registration controller is located in a base station controller in the base station. The traffic channel registration controller sends and receives registration messages in a traffic channel. The traffic channel registration controller communicates with the mobile switching center of the wireless network to cause the mobile switching center to register the mobile station in the wireless network. The traffic channel registration controller is capable of sending a registration accepted order to the mobile station in a traffic channel to confirm a successful registration of the mobile station in the wireless network.

It is an object of the present invention to provide a base station that is capable of receiving registration messages in a traffic channel from a mobile station.

It is also an object of the present invention to provide a mobile station that is capable of sending registration messages in a traffic channel to a base station.

It is another object of the present invention to provide a traffic channel registration controller in a base station that is capable of sending and receiving mobile station registration messages in a traffic channel.

It is yet another object of the present invention to provide a mobile switching center in a wireless network that is capable of registering a mobile station using registration messages that are sent in a traffic channel.

It is an additional object of the present invention to provide a mobile switching center in a wireless network that is capable of sending a registration message request to a mobile station to request the mobile station to register in the wireless network using registration messages sent in a traffic channel.

The foregoing has outlined rather broadly several features of this disclosure so that those skilled in the art may better understand the Detailed Description of the Invention that follows. Additional features may be described later in this document. Those skilled in the art should appreciate that they may readily use the concepts and the specific embodiments disclosed as a basis for modifying or designing other structures for carrying out the same purposes of this disclosure. Those skilled in the art should also realize that such equivalent constructions do not depart from the spirit and scope of the invention in its broadest form.

Before undertaking the Detailed Description of the Invention below, it may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, or software, or a combination of at least two of the same. It should be noted that the functionality associated with any particular controller may be centralized or distributed, whether locally or remotely. Definitions for certain words and phrases are provided throughout this patent document, and those of ordinary skill in the art should understand that in many, if not most instances, such definitions apply to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary wireless network according to an advantageous embodiment of the present invention;

FIG. 2 illustrates an exemplary base station in more detail according to an advantageous embodiment of the present invention;

FIG. 3 illustrates a chart of call flows showing a registration message from a wireless mobile station to mobile switching center in accordance with the principles of the present invention; and

FIG. 4 illustrates a chart of call flows showing a registration request message from a mobile switching center to a wireless mobile station in accordance with the principles of the present invention.

### DETAILED DESCRIPTION OF THE INVENTION

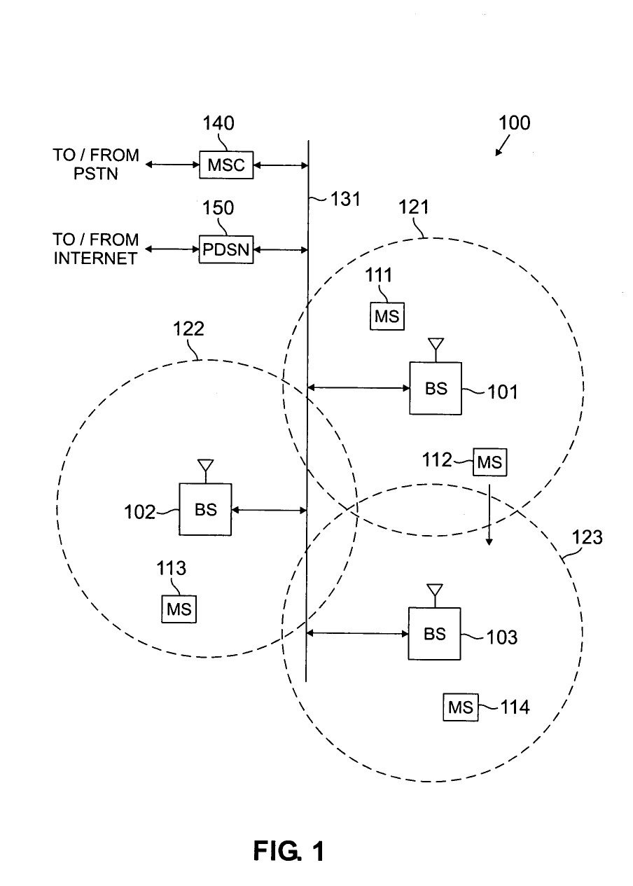

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged telecommunications network.

FIG. 1 illustrates exemplary wireless network 100 according to one embodiment of the present invention. Wireless network 100 comprises a plurality of cells 121-123, each containing one of the base stations, BS 101, BS 102, or BS 103. Base stations 101-103 communicate with a plurality of mobile stations (MS) 111-114 over code division multiple access (CDMA) channels. Mobile stations 111-114 may be any suitable wireless devices, including conventional cellular radiotelephones, PCS handset devices, personal digital assistants, portable computers, telemetry devices, and the like, which are capable of communicating with the base stations via wireless links. The present invention is not limited to mobile devices. Other types of access terminals, including fixed wireless terminals, may be used. However, for the sake of simplicity, only mobile stations are shown and discussed hereafter.

Dotted lines show the approximate boundaries of the cells 121-123 in which base stations 101-103 are located. The cells are shown approximately circular for the purposes of illustration and explanation only. It should be clearly understood that the cells may have other irregular shapes, depending on the cell configuration selected and natural and man-made obstructions.

As is well known in the art, cells 121-123 are comprised of a plurality of sectors (not shown), each sector being illuminated by a directional antenna coupled to the base station. The embodiment of FIG. 1 illustrates the base station in the center of the cell. Alternate embodiments position the directional antennas in corners of the sectors. The system of the present invention is not limited to any one cell configuration.

In one embodiment of the present invention, BS 101, BS 102, and BS 103 each comprise a base station controller (BSC) and a base transceiver subsystem (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces, and RF transmitters and RF receivers. For the purpose of simplicity and clarity in explaining the operation of the present invention, the base transceiver subsystem in each of cells 121, 122, and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Line 131 also provides the connection path to transfer control signals between MSC 140 and BS 101, BS 102 and BS 103 used to establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in a base station controller (BSC) with switch elements in MSC 140. Those skilled in the art will recognize that the connections on line 131 may provide a transmission path for transmission of analog voice band signals, a digital path for transmission of voice signals in the pulse code modulated (PCM) format, a digital path for transmission of voice signals in an Internet Protocol (IP) format, a digital path for transmission of voice signals in an asynchronous transfer mode (ATM) format, or other suitable connection transmission protocol. Those skilled in the art will recognize that the connections on line 131 may provide a transmission path for transmission of analog or digital control signals in a suitable signaling protocol.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell 121 and is in communication with BS 101. MS 113 is located in cell 122 and is in communication with BS 102. MS 114 is located in cell 123 and is in communication with BS 103. MS 112 is also located close to the edge of cell 123 and is moving in the direction of cell 123, as indicated by the direction arrow proximate MS 112. At some point, as MS 112 moves into cell 123 and out of cell 121, a hand-off will occur.

As is well known to those skilled in the art, the handoff procedure transfers control of a call from a first cell to a second cell. A handoff may be either a “soft handoff” or a “hard handoff.” In a “soft handoff” a connection is made between the mobile station and the base station in the second cell before the existing connection is broken between the mobile station and the base station in the first cell. In a “hard handoff” the existing connection between the mobile station and the base station in the first cell is broken before a new connection is made between the mobile station and the base station in the second cell.

As MS 112 moves from cell 121 to cell 123, MS 112 detects the pilot signal from BS 103 and sends a Pilot Strength Measurement Message to BS 101. When the strength of the pilot transmitted by BS 103 and received and reported by MS 112 exceeds a threshold, BS 101 initiates a soft hand-off process by signaling the target BS 103 that a handoff is required as described in TIA/EIA IS-95 or TIA/EIA IS-2000.

BS 103 and MS 112 proceed to negotiate establishment of a communications link in the CDMA channel. Following establishment of the communications link between BS 103 and MS 112, MS 112 communicates with both BS 101 and BS 103 in a soft handoff mode. Those acquainted with the art will recognize that soft hand-off improves the performance on both forward (BS to MS) channel and reverse (MS to BS) channel links. When the signal from BS 101 falls below a predetermined signal strength threshold, MS 112 may then drop the link with BS 101 and only receive signals from BS 103. The call is thereby seamlessly transferred from BS 101 to BS 103. The above-described soft hand-off assumes the mobile station is in a voice or data call. An idle hand-off is the hand-off between cells of a mobile station that is communicating in the control or paging channel.

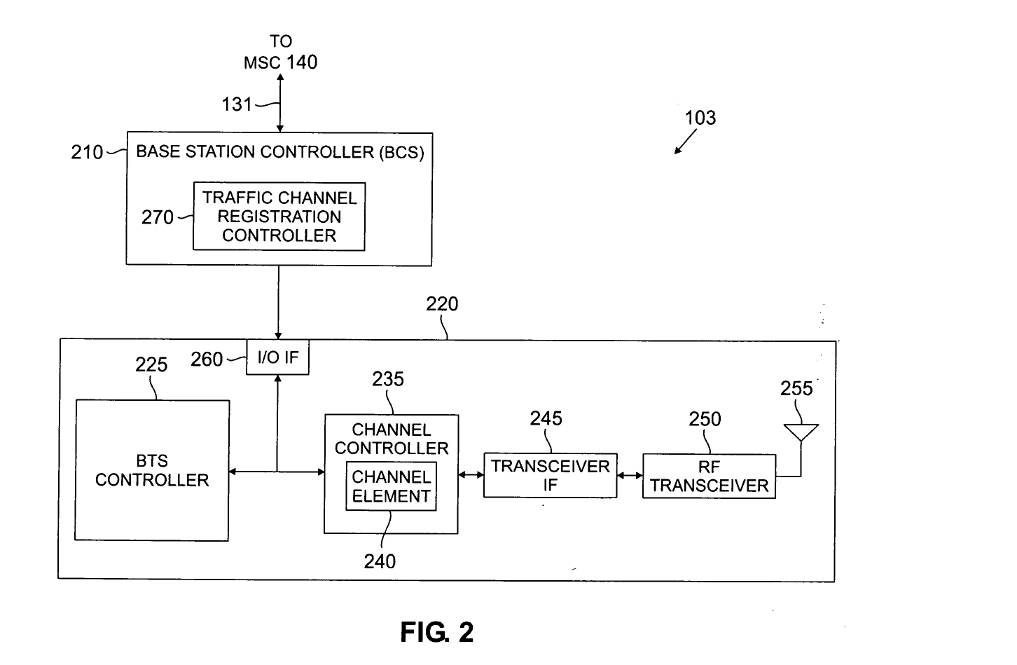

FIG. 2 illustrates exemplary base station BS 103 in more detail according to an advantageous embodiment of the present invention. Base station BS 103 comprises base station controller BSC 210 and base transceiver subsystem BTS 220. Base station controllers and base transceiver subsystems were described previously in connection with FIG. 1.

BSC 210 manages the resources in cell 123 including BTS 220. As described above, BSC 210 is coupled to MSC 140 over data communication line 131. Exemplary BTS 220 comprises BTS controller 225, channel controller 235 that contains exemplary channel element 240, transceiver interface (IF) 245, RF transceiver unit 250, and antenna array 255. Input/output interface (I/O IF) 260 couples BTS 220 to BSC 210.

BTS controller 225 controls the overall operation of BTS 220 and interfaces with BSC 210 through I/O IF 260. BTS controller 225 directs the operation of channel controller 235. Channel controller 235 contains a number of channel elements such as channel element 240. The channel elements perform bi-directional communications in the forward and reverse links. Depending on the air interface used by the system of BS 103, the channel elements engage in time division multiple access (TDMA), frequency division multiple access (FDMA), or code division multiple access (CDMA) communications with the mobile stations in cell 123.

Transceiver IF 245 transfers the bi-directional channel signals between channel controller 235 and RF transceiver 250. Transceiver IF 245 converts the radio frequency signal from RF transceiver 250 to an intermediate frequency (IF). Channel controller 235 then converts this intermediate frequency (IF) to baseband frequency. Additionally, RF transceiver 250 may contain an antenna selection unit to select among different antennas in antenna array 255 during both transmit and receive operations.

Antenna array 255 comprises a number of directional antennas that transmit forward link signals, received from RF transceiver 250, to mobile stations in the sectors covered by BS 103. Antenna array 255 also receives reverse link signals from the mobile stations and sends the signals to RF transceiver 250. In a preferred embodiment of the present invention, antenna array 255 is a multi-sector antenna, such as a six-sector antenna, in which each antenna is responsible for transmitting and receiving in a sixty degree (60°) arc of coverage area.

BS 103 of the present invention is not limited to the architecture described above. The architecture may be different depending on the type of air interface standard used by the wireless system. Additionally, the present invention is not limited by the frequencies used. Different air interface standards require different frequencies.

In an advantageous embodiment of the present invention, base station controller BSC 210 comprises a microprocessor (also known as a microcontroller) and a memory unit. The microprocessor and memory unit of base station controller BSC 210 are not shown in FIG. 2. BSC 210 is capable of executing software applications stored in the memory unit. BSC 210 also comprises a traffic channel registration controller 270. As will be more fully described, traffic channel registration controller 270 is capable of carrying out the present invention. Traffic channel registration controller 270 is an integral part of BSC 210. In an alternate embodiment of the present invention, traffic channel registration controller 270 may be located within BTS controller 225.

As a first example of the operation of the present invention, assume that wireless mobile station 112 is not registered in wireless network 100. As wireless mobile station 112 moves toward BS 103 in cell 123, the user of wireless mobile station 112 desires to register wireless mobile station 112. In accordance with the principles of the present invention, traffic channel registration controller 270 in BTS controller 225 allows mobile station 112 to send registration messages over a traffic channel.

Assume that traffic channel registration controller 270 receives a Registration message from wireless mobile station 112 on a reverse traffic channel. Then traffic channel registration controller 270 sends notification to mobile switching center (MSC) 140 in a Location Update Request message. Mobile switching center (MSC) 140 registers wireless mobile station MS 112 and sends a Location Update Acceptance message to traffic channel registration controller 270. Traffic channel registration controller 270 then sends a Registration Accepted Order to wireless mobile station 112 on a forward traffic channel.

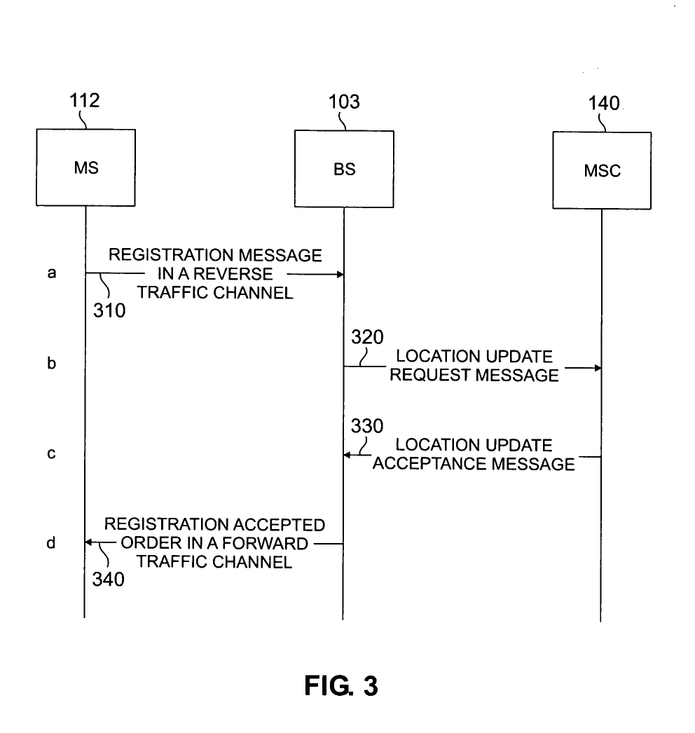

FIG. 3 illustrates a chart of call flows showing a Registration message sent from wireless mobile station MS 112 to mobile switching center (MSC) 140 in accordance with the principles of the present invention. At time “a” mobile station MS 112 sends the Registration message 310 to base station BS 103 on a reverse traffic channel. At time “b” base station BS 103 sends a Location Update Request message 320 to MSC 140. MSC 140 then registers wireless mobile station MS 112 in wireless network 100. At time “c” MSC 140 sends a Location Update Acceptance message 330 to BS 103. At time “d” BS 103 sends a Registration Accepted Order 340 to mobile station MS 112 on a forward traffic channel. In this manner wireless mobile station MS 112 becomes registered in wireless network 100 using messages transmitted over traffic channels.

As a second example of the operation of the present invention, assume that wireless mobile station MS 112 is not registered in wireless network 100. As wireless mobile station MS 112 moves toward BS 103 in cell 123, the mobile switching center (MSC 140) determines that wireless mobile station MS 112 is not registered. Then mobile switching center (MSC) 140 sends a Registration Request message to traffic channel registration controller 270 in base station BS 103. Traffic channel registration controller 270 forwards the Registration Request message to wireless mobile station MS 112 on a forward traffic channel.

In response, wireless mobile station MS 112 sends back a Registration message to traffic channel registration controller 270 on a reverse traffic channel. Then traffic channel registration controller 270 sends notification to mobile switching center (MSC) 140 in a Location Update Request message. Mobile switching center (MSC) 140 registers wireless mobile station MS 112 and sends a Location Update Acceptance message to traffic channel registration controller 270. Traffic channel registration controller 270 then sends a Registration Accepted Order to wireless mobile station MS 112 on a forward traffic channel.

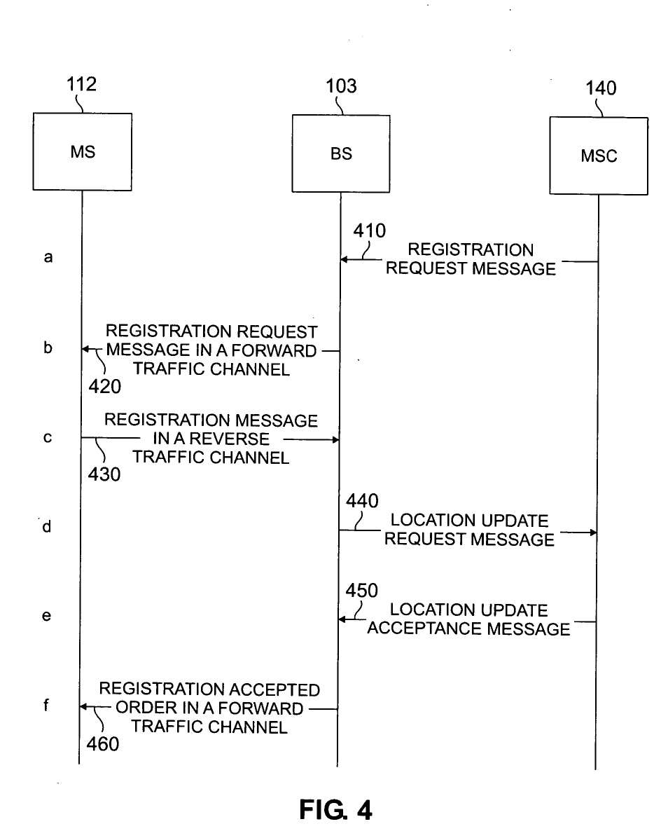

FIG. 4 illustrates a chart of call flows showing a Registration Request message from mobile switching center 140 to wireless mobile station MS 112 in accordance with the principles of the present invention. At time “a” mobile switching center 140 sends a Registration Request message 410 to base station BS 103. At time “b” base station BS 103 sends Registration Request message 420 to mobile station MS 112 on a forward traffic channel. At time “c” mobile station MS 112 sends a Registration message 430 to BS 103 on a reverse traffic channel. At time “d” BS 103 sends a Location Update Request message 440 to MSC 140. MSC 140 then registers wireless mobile station MS 112 in wireless network 100. At time “e” MSC 140 sends a Location Update Acceptance message 450 to BS 103. At time “f” BS 103 sends a Registration Accepted Order 460 to mobile station MS 112 on a forward traffic channel. In this manner wireless mobile station MS 112 becomes registered in wireless network 100 using messages transmitted over traffic channels in response to Registration Request message 410 from MSC 140.

The system and method of the present invention provides additional flexibility and efficiency in the operation of a wireless network. For example, assume that a user of a mobile station is on an active packet data call. A voice call arrives at the mobile station for the user. The mobile station does not have concurrent service feature capability to receive both calls. The user decides to receive the voice call and let the packet data call go dormant. The packet data call goes dormant and the user travels to another wireless network and the voice call continues. The new wireless network requires certain user profile information for the packet data call. The system and method of the present invention allows the user profile information to be transmitted to the new wireless network over the traffic channel with the voice call. The ability to transfer registration information over a traffic channel enhances the overall efficiency of the wireless network system.

Now consider another example. A mobile station that is on an active packet data call (no voice) is handed off to a target wireless network with an inter-system hard handoff. The mobile switching center (MSC) in the target wireless network implements an after-handoff registration functionality and registers the mobile station with the MSC's Home Location Register (HLR). While the mobile station is still on the active packet data call (i.e., the traffic channel is still active) the mobile station is handed back to the original wireless network that was originally serving the mobile station.

The MSC in the original wireless network, however, does not support an after-handoff registration functionality. When the packet data call ends (or goes dormant) the mobile station enters an idle state. The mobile station compares the System Identification Number (SID)/Network Identification Number (NID) information that is broadcast by the serving cell with the SID/NID information that is stored in the mobile station. The mobile station uses the SID/NID information to determine whether it needs to register over the air.

In this case the mobile station will determine that it does not need to register over the air because the SID/NID information that is broadcast matches the SID/NID information that is stored in the mobile station. This results in a mismatch between the registration location information stored in the mobile station's HLR and the actual location of the mobile station. The mobile station will then be unavailable for some time (until the mobile station registers) for delivery of circuit mode services and tele-services.

The system and method of the present invention allows the mobile switching center (NMC) to transmit a request to the mobile station to perform the registration process. The mobile station will respond by registering over the traffic channel. The registration of the mobile station will then allow traffic calls to go through seamlessly.

These examples are merely illustrative. Many other valuable applications of the system and method of the present invention may also be identified. Although the present invention has been described in detail, those skilled in the art should understand that they may make various changes, substitutions and alterations herein without departing from the spirit and scope of the invention in its broadest form.

1. For use in a wireless communication system comprising a mobile switching center, at least two base stations and at least one mobile station, an apparatus for providing mobile station registration in a traffic channel, wherein the apparatus comprises:
at least one base station that is capable of receiving in a traffic channel at least one mobile station registration message from at least one mobile station; and
at least one mobile station that is capable of sending in a traffic channel at least one mobile station registration message to least one base station.

2. The apparatus as set forth in claim 1 wherein:
said at least one base station is capable of receiving in a reverse traffic channel a registration message from said at least one mobile station;
said at least one base station is capable of causing said mobile switching center to register said at least one mobile station in said wireless communication system; and
said at least one base station is capable of sending a registration accepted order to said at least one mobile station in a forward traffic channel.

3. The apparatus as set forth in claim 2 wherein said mobile switching center is capable of causing a registration request message to be sent to said at least one mobile station in a traffic channel.

4. The apparatus as set forth in claim 1 wherein said at least one base station comprises a traffic channel registration controller that is capable of one of: sending mobile station registration messages in a traffic channel to said at least one mobile station and receiving mobile station registration messages in a traffic channel from said at least one mobile station.

5. The apparatus as set forth in claim 4 wherein:
said traffic channel registration controller is capable of receiving in a reverse traffic channel a registration request message from said at least one mobile station;
said traffic channel registration controller is capable of causing said mobile switching center to register said at least one mobile station in said wireless communication system; and
said traffic channel registration controller is capable of sending a registration accepted order to said at least one mobile station in a forward traffic channel.

6. The apparatus as set forth in claim 5 wherein said mobile switching center is capable of sending a registration request message to said traffic channel registration controller for forwarding to said at least one mobile station in a traffic channel.

7. The apparatus as set forth in claim 6 wherein said at least one base station is capable of sending a location update request message to said mobile switching center and is capable of receiving a location update acceptance message from said mobile switching center.

8. A wireless communication system comprising:
a mobile switching center and a plurality of base stations capable of communicating with a plurality of mobile stations; and
an apparatus for providing mobile station registration in a traffic channel, wherein the apparatus comprises:
at least one base station of said plurality of base stations that is capable of receiving in a traffic channel at least one mobile station registration message from at least one mobile station of said plurality of mobile stations; and
at least one mobile station of said plurality of mobile stations that is capable of sending in a traffic channel at least one mobile station registration message to least one base station of said plurality of base stations.

9. The wireless communication system as set forth in claim 8 wherein:
said at least one base station is capable of receiving in a reverse traffic channel a registration message from said at least one mobile station;
said at least one base station is capable of causing said mobile switching center to register said at least one mobile station in said wireless communication system; and
said at least one base station is capable of sending a registration accepted order to said at least one mobile station in a forward traffic channel.

10. The wireless communication system as set forth in claim 9 wherein said mobile switching center is capable of causing a registration request message to be sent to said at least one mobile station in a traffic channel.

11. The wireless communication system as set forth in claim 8 wherein said at least one base station comprises a traffic channel registration controller that is capable of one of: sending mobile station registration messages in a traffic channel to said at least one mobile station and receiving mobile station registration messages in a traffic channel from said at least one mobile station.

12. The wireless communication system as set forth in claim 11 wherein:
said traffic channel registration controller is capable of receiving in a reverse traffic channel a registration request message from said at least one mobile station;
said traffic channel registration controller is capable of causing said mobile switching center to register said at least one mobile station in said wireless communication system; and
said traffic channel registration controller is capable of sending a registration accepted order to said at least one mobile station in a forward traffic channel.

13. The wireless communication system as set forth in claim 12 wherein said mobile switching center is capable of sending a registration request message to said traffic channel registration controller for forwarding to said at least one mobile station in a traffic channel.

14. The wireless communication system as set forth in claim 13 wherein said at least one base station is capable of sending a location update request message to said mobile switching center and is capable of receiving a location update acceptance message from said mobile switching center.

15. For use in a wireless communication system comprising a mobile switching center, at least two base stations and at least one mobile station, a method for registering at least one mobile station in said wireless communication system, wherein the method comprises the steps of:
sending from said at least one mobile station at least one mobile station registration message in a traffic channel to at least one base station;
receiving in said at least one base station said at least one mobile station registration message sent in a traffic channel from said at least one mobile station; and
registering said at least one mobile station in said mobile switching center of said wireless communication system.

16. The method as set forth in claim 15 further comprising the steps of:
sending a registration message on a reverse traffic channel from said at least one mobile station to said at least one base station; and
sending a registration accepted order message on a forward traffic channel from said at least one base station to said at least one mobile station.

17. The method as set forth in claim 16 further comprising the steps of:
sending a location update request message from said at least one base station to said mobile switching center after said at least one base station receives said registration request message from said at least one mobile station; and
receiving in said at least one base station a location update acceptance message from said mobile switching center before said at least one base station sends a registration accepted order message to said at least one mobile station.

18. The method as set forth in claim 15 further comprising the steps of:
sending a registration request message from a mobile switching center to said at least one base station; and
sending said registration request message from said at least one base station in a forward traffic channel to said at least one mobile station.

19. The method as set forth in claim 18 further comprising the steps of:
in response to receiving said registration request message in a forward traffic channel from said at least one base station, sending a registration message in a reverse traffic channel from said at least one mobile station to said at least one base station;
sending a location update request message from said at least one base station to said mobile switching center;
receiving in said at least one base station a location update acceptance message from said mobile switching center; and
sending a registration accepted order message in a forward traffic channel from said at least one base station to said at least one mobile station.

20. The method as set forth in claim 15 further comprising the steps of:
sending from said at least one mobile station at least one mobile station registration message in a traffic channel to a traffic channel registration controller in at least one base station;
receiving in said traffic channel registration controller in said at least one base station said at least one mobile station registration message sent in a traffic channel from said at least one mobile station; and
using said traffic channel registration controller to cause said mobile switching center to register said at least one mobile station in said wireless communication system.
